(19) United States
(12) Patent Application Publication
(10) Pub. No.: US 2016/0364655 A1
(43) Pub. Date: Dec. 15, 2016

(54) System to generate Logical Design for MPP Clusters using self-learning model

(71) Applicants: Shahzad Muhammad, Oakville (CA); ADNAN HUSSAIN, Dubai (AE); MUJTABA QADRI, Oakville (CA)

(72) Inventors: Shahzad Muhammad, Oakville (CA); ADNAN HUSSAIN, Dubai (AE); MUJTABA QADRI, Oakville (CA)

(21) Appl. No.: 15/092,618

(22) Filed: Apr. 7, 2016

(51) Int. Cl. G06N 99/00; G06N 5/04; G06F 17/30; G06N 7/00

(52) U.S. Cl. CPC G06N 99/005; G06N 7/005; G06N 5/04; G06F 17/30598; G06F 17/30554

(57) ABSTRACT

Haystaxs provides a framework which transforms the cluster into a self-learning database by suggesting a logical design. This is achieved by extracting the schema definition and query logs from the MPP cluster; synthesize this information to build a probabilistic model using the abstract syntax tree. This information is passed through the rule engine and model evaluator to generate recommendations which would improve the cluster performance.

### BRIEF SUMMARY

The present invention relates to a method to analyze MPP clusters performance, project trend analysis and provide recommendation to enhance cluster performance and query response time.

### BACKGROUND OF THE INVENTION

Today businesses are experiencing tremendous challenges to know about their customers and adapt quickly to enhance experience of valued customers. Exponential data growth has made this challenge even more complex, with multiple sources of internal and external data. To manage this data, organizations require “Big Data” technologies and IT professionals are required to plan, manage, support and operate these massive data clusters.

To keep this huge data optimized is an uphill task and requires long hours of analysis to understand schema, structure and workload of these tables and queries.

### BRIEF SUMMARY OF INVENTION

Today in data warehouse environment performance improvement is often a concern, MPP clusters are complex, and demand for experienced database administrators is high, Haystaxs provides a framework that can support database administrators by suggesting a logical design which transforms the cluster into a self-learning database.

It also provides insights into the cluster usage behavior, so that the DBA can easily identify and fix issues. Haystaxs brings the self-learning capability to the leading MPP platforms in the market today; such as Amazon Redshift, IBM Netezza, Greenplum, HAWQ, Teradata, Hive, Impala.

Haystaxs fetches the Query Logs from the cluster every (n) hours, in addition to this the current table schema, statistics and other key information is also refreshed each interval. Query logs, schema and other key information are fed into Workload Processing; via Schema Analyzer and SQL Parser.

Haystaxs Workload Processing provides a unique recipe; where the input (Extracts Projections, Table structure, partitions, Joins, Selections) are analyzed to establish the workload model, inter-links between tables and Abstract syntax trees. This information is synthesized to establish a dashboard view for drill-down and drill through analysis of the workload.

This metadata extracted and analyzed query logs are utilized by the next module to produce a visual representation of the model. Selecting a node (representing a table) in the model, provides a unique perspective about the table which shows its interaction with the rest of the tables and the nomenclature of the table itself; to understand current state of data and schema structure. The nomenclature includes information such as storage model, compression, skew, partitioning scheme, join columns, usage frequency, workload score, execution time and model score. (This information is not provided by any other tool in the market at the moment)

Last but not the least; Haystaxs provides optimization recommendations based on the probalistic-scoring model to Adminstrators; which can be used as is or tweaked to introduce performance improvements for any MPP environment.

### BRIEF DISCRETION OF DRAWINGS

FIG. 1: Depicts the flow diagram of how haystaxs pulls schema and query logs from MPP cluster, analyzes and builds visual representation

FIG. 2: Represents the conceptual diagram of the elements and algorithms used to generate recommendation to enable self-learning

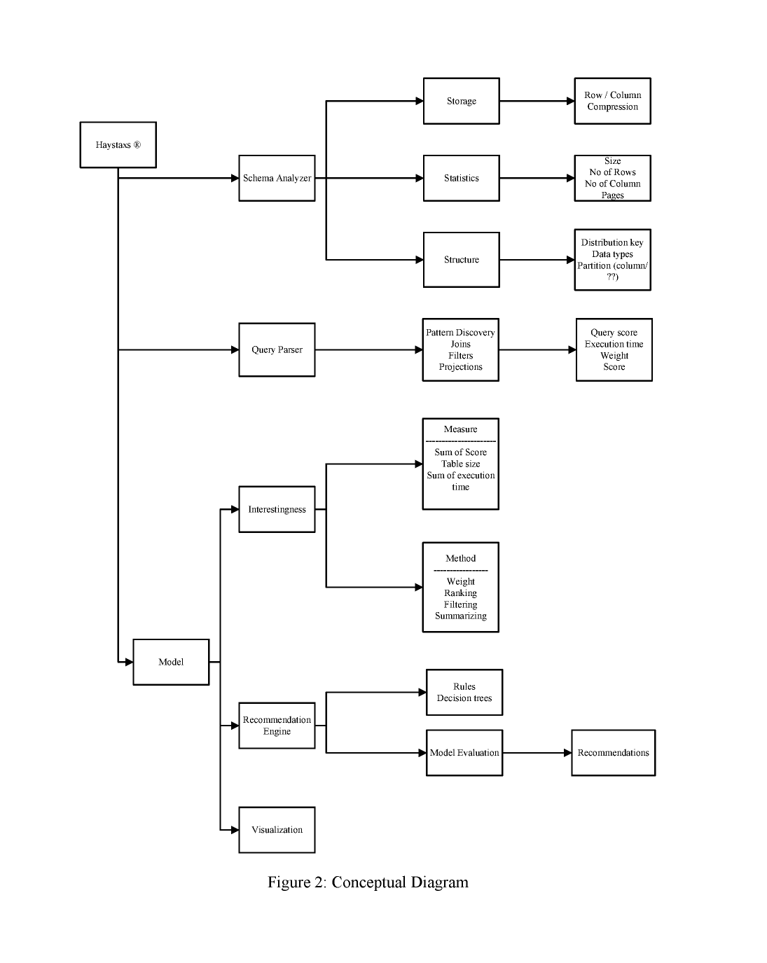

### DETAILED DISCRETION OF THE INVENTION

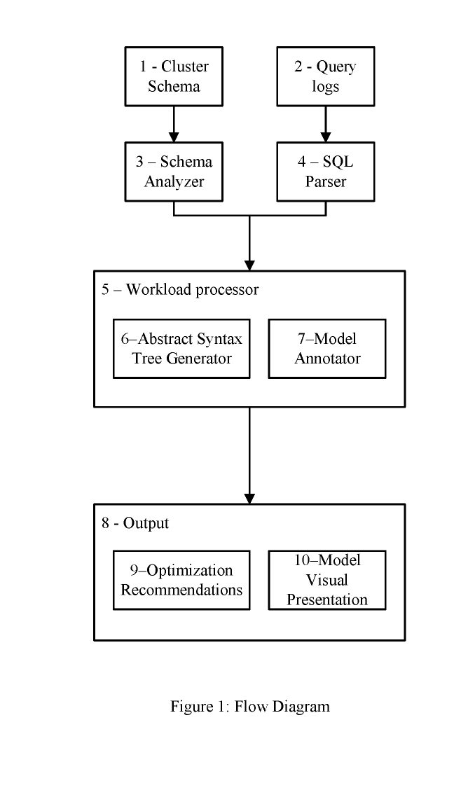

With reference to FIG. 1, Haystaxs is a simple flow to extract valuable information about connected MPP platforms.

In step 1, Cluster schema contains critical and important information about cluster, schema, and structure which Haystaxs pulls automatically.

In step 2, Query logs are pulled and fed into SQL parser

In step 3, Schema analyzer pulls information from a cluster schema and feeds it to the workload processor.

In step 4, SQL parser analyses the query logs loaded. This prepares parsed information to work load processor.

In step 5, Schema information and parsed query information is used to analyze syntax and generate syntax tree. In addition to this the model annotator prepares metadata for further visual presentation.

In step 6, Syntax tree generator provides critical attributes and interlinks to be used in visual representation of schema and query logs pulled from clusters.

In step 7, The model annotator prepares and organizes metadata to prepare various output results on Haystaxs dashboard

In step 8, Haystaxs uses the analyzed data in workload processor and prepares recommendations and various informative visual outputs

In step 9, Optimization recommendations provides specific recommendations for each table in the cluster

In step 10, Model visual presentation prepares various charts, graphs and visual presentations show in-depth analysis on workload, query and tables in connect MPP cluster.

1. Haystaxs uses probabilistic machine learning algorithms to score the model. Model is created by parsing query logs and table catalog. It then periodically generates recommendations to increase cluster throughout. Haystaxs integrates with following MPP (Massive Parallel Processing) platforms including Amazon Redshift, IBM Netezza, Greenplum, HAWQ, Teradata, Hive, Impala.

2. Based on claim 1, Haystaxs offers self-learning capability for any leading MPP solution.

3. Based on claim 1, Haystaxs provides customizable pull mechanism to pull query load from cluster.

4. Based on claim 1, Haystaxs gives important information such as workload score, execution time, usage frequency, model score, storage (compressed, uncompressed), no of columns, compression ratio, no of rows, compression level, storage mode, compressed, colummner and skew.

5. Based on claim 1, Havaaxs provides columns and their joins statistics.

6. Based on claim 1, Haystaxs provides join details of any table and score based of frequency of their usage.

7. Based on claim 1, Haystaxs provide partitioning details of any table selected.

8. Based on claim 1, Haystaxs provides visuals of cluster based on score, size and time.

9. Based on claim 1, Haystaxs provides query load based on duration for each type query such as select, insert, alter, transaction, truncate, update, copy, maintenance, lock and multiple SQL queries.

10. Based on claim 1, Haystaxs provides query load based on counts for each, type query such as select, insert, alter, transaction, truncate, update, copy, maintenance, lock and multiple SQL queries.

11. Based on claim 1, Haystaxs provides hourly query analysis for select, copy, insert, truncate, update, look, multiple statements.

12. Based on claim 1, Haystaxs provides hourly query analysis can be changed to average and sum for each bout.

13. Based on claim 1, Haystaxs provides comparison for the query analyzed.

14. Based on claim 1, Haystaxs comparison window is customizable to hourly, 12 hours, 24 hours, weekly, last two week, last month and quarter.

15. Based on claim 1, Haystaxs provides a mechanism where multiple clusters can be configured to analyze performance.

16. Based on claim 1, Haystaxs provides a visual tree to explore any selected cluster.

17. Based on claim 1, Haystaxs ability to view query load analyzed for any cluster, schema, query and user.

18. Based on claim 1, Haystaxs enables administrators to sort dynamically query view based on start time, duration, query; type and filter based on these critera.

19. Haystaxs provides administrators audit trail (also called audit log) is a chronological record, set of records that provide documentary evidence of the sequence of activities that have affected at any time a specific operation procedure, or event.

20. Haystaxs also has a visualizer screen where Data Architects & DBA's can visualize their workload over time, this ensures that they know how their workloads are cranking and have the comfort that thousands of table across multiple schemas are being analyzed and monitored for performance tuning opportunities. Visual view can be filtered for any specific schema, user and table count.
